(19) United States
(12) Patent Application Publication
(10) Pub. No.: US 2007/0073517 A1
(43) Pub. Date: Mar. 29, 2007

(54) Method of predicting input

(75) Inventor: Krishna Prasad Panje, Bangaloro (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/577,109

(22) PCT Filed: Oct. 18, 2004
(86) PCT No.: PCT/IB04/52119

§ 371 Date: Apr. 25, 2006

(30) Foreign Application Priority Data
Oct. 30, 2003 (EP) 03104022.3

(51) Int. Cl. G06F 17/18; G06F 19/00; G06F 15/00

(52) U.S. Cl. 702/181

(57) ABSTRACT

A method of predicting input of electronic objects in a communication device is described. The method includes the steps of: (a) establishing a first database of electronic objects susceptible to being inserted into multimedia messages composable on the device; (b) establishing a second database of electronic object attributes; (c) establishing one or more associations between at least one object of the first database and at least one corresponding attribute of the second database; (d) receiving from a user of the device a request for inclusion of one or more of the objects into a multimedia message, said request including at least one input argument; (e) matching said at least one input argument with said at least one attribute in the second database and thereby identifying one or more objects corresponding to the at least one input argument and its associated at least one attribute; and (f) presenting to the user a display representation of said one or more objects corresponding to said at least one argument.

### FIELD OF THE INVENTION

The present invention relates to methods of predicting input of electronic objects, for example, enhanced messaging service (EMS), multimedia message service (MMS), or e-mail objects, in communication devices. Moreover, the present invention also relates to communication devices, for example, mobile telephones or Internet-connected personal computers, operating in accordance with the method.

### BACKGROUND OF THE INVENTION

Communication devices such as mobile telephones are well known and generally used worldwide. Earlier mobile telephones were arranged to support substantially speech communication. On account of improvements in display facilities of mobile telephones, for example, the incorporation of back-lit liquid crystal pixel matrix displays therein, it has more recently become increasingly common for mobile telephone users to communicate by way of text messages. Moreover, it has become popular to include other types of information-conveying graphical symbols popularly known as “emoticons”.

An emoticon is defined as a hieroglyphic character that is formed by using a plurality of typical characters or special characters in combination to represent a mobile telephone user's emotions. The word “emoticon” is a noun compound of “emotion” and “icon”. Emoticons are part of a language unique to cyber space, by which emotions, symbols, personalities, jobs and physical macroscopic items are represented by using characters, symbols and digits available on the keyboard of a computer or digital communicating device such as a mobile telephone. They are widely used in cyber space since they are easily understood and easily facilitate a description of an expression of subtle emotions of a user.

The preparation and transmission of emoticons are known. For example, United States patent US2002/0077135 describes a method of easily inputting emoticons. In the method implemented in a mobile terminal, for example, a mobile telephone, a plurality of emoticons are formed by utilizing a plurality of typical characters and special characters in combination; the emoticons are grouped and stored by groups in the mobile terminal. The mobile terminal is arranged to be susceptible to entering into an emoticon input mode of operation, displaying the stored emoticon groups, displaying the emoticons of an emoticon group selected by a user, and transmitting a short message system (SMS) message including at least one emoticon selected by the user.

Moreover, published international PCT patent application PCT/US02/24647 (WO 03/017681) describes an apparatus, such as a communication device, which is provided with emoticon input logic associated with an input key to improve the ease-of-use of the apparatus for entering emoticons, for example, into a text message, whilst the apparatus is operating, for example, in a text mode. Responsive to a selection of the associated input key, one or more emoticons are displayed for selection. A user may “scroll” the one or more displayed emoticons to “select” an emoticon. In one example apparatus described, current focus is placed on one of the displayed emoticons, and the emoticon with the current focus is automatically selected upon elapse of a predetermined amount of time after the current focus was placed.

The inventor has appreciated that, despite attempts in the prior art to make emoticon entry easier, it is still a laborious and often tedious task to include emoticons in messages, especially when using miniaturized equipment such as contemporary mobile telephones. In order to render such data entry potentially easier, the inventor has devised the present invention.

### OBJECT AND SUMMARY OF THE INVENTION

A first object of the present invention is to provide a method of predicting input of electronic objects, for example, enhanced messaging service (EMS) or multimedia messaging service (MMS) objects, in communication devices, for example, mobile telephones.

A second object of the invention is to provide a communication device implementing a method of predicting input of electronic objects, for example, EMS or MMS objects, to render the device easier to use.

According to a first aspect of the present invention, there is provided a method of predicting input of electronic objects in a communication device, the method including the steps of:

(a) establishing a first database of electronic objects susceptible to being inserted into multimedia messages composable on the device;

(b) establishing a second database of electronic object attributes;

(c) establishing one or more associations between at least one object of the first database and at least one corresponding attribute of the second database;

(d) receiving from a user of the device a request for inclusion of one or more of the objects into a multimedia message, said request including at least one input argument;

(e) matching said at least one input argument with said at least one attribute in the second database and thereby identifying one or more objects corresponding to the at least one input argument and its associated at least one attribute; and

(f) presenting to the user a display representation of said one or more objects corresponding to said at least one argument.

The invention has the advantage that it is capable of predicting input of electronic objects, for example, in mobile telephone devices.

It will be appreciated in step (d) that a request for inclusion of one or more of the objects can be either implicit or explicit. For example, it may be a default function of the communication device, for example, time and/or temperature and/or spatial location; alternatively, the request can be explicit corresponding to the user actively inputting the request, for example, by way of a keyboard of the device and/or by way of voice-activated input.

Preferably, said one or more identified objects from step (e) are presented in a prioritised manner relative to other objects in the first database. Such a prioritised manner is capable of circumventing a need for the user to search through all electronic objects provided on the device but merely a sub-set thereof. More preferably, said one or more identified objects from step (e) are presented firstly to the user. In other words, electronic objects are preferably presented to the user in a descending order of relevance.

Preferably, said one or more identified objects from step (e) are presented in an order wherein objects with most matching attributes to said one or more arguments are presented firstly in progressive order to those objects with least matching attributes to said one or more arguments.

Preferably, at least one of the objects of the first database is associated with a plurality of corresponding attributes in the second database.

Preferably, said one or more attributes include at least one of:

(a) relationship of the user to one or more intended recipients of the message;

(b) a degree of desired informality of said message;

(c) chronological time of at least one of an instance of generation of the message and an instance of despatch of said message;

(d) ambient conditions of the user when composing the message, said conditions including at least one of ambient illumination intensity, ambient temperature, ambient humidity, ambient altitude;

(e) geographical spatial location of the user when at least one of composing and sending the message;

(f) location of the user in accordance with the location function;

(g) a previous history of a preferred selection of said one or more objects exercised by the user;

(h) at least one of a telephone number and a cyberspace address of said one or more intended recipients for the message; and

(i) a word already part of the message.

Preferably, in the method, the device includes position measuring means for determining its geographical spatial location. More preferably, said measuring means includes at least one of an A-GPS and an E-OTD measuring apparatus.

Preferably, in the method, the device is operable to relate the geographical spatial location to the user location in accordance with the location function. Such an association enables the device to select automatically a subset of suitable objects depending on location without a need for the user to enter spatial location data into the devices, thereby rendering the device easier to use. Location function includes, for example, “home”, “work”, “club”, “mistress' bedroom”, and so forth

Preferably, in the method, the device includes graphical displaying means and is operable to display a representation of at least one of the identified objects on the displaying means together with one or more of its associated attributes.

Preferably, in the method, the device includes graphical displaying means for representing said identified objects in a manner susceptible to interrogation from the user by way of scrolling representation of the identified objects.

Preferably, in the method, said first and second databases are substantially co-located in the memory of the device.

Preferably, in the method, at least part of said first and second databases is provided spatially remote with respect to the device.

Preferably, in the method, the device is arranged to be operable to present to the user objects grouped in accordance with one or more of their attributes.

Preferably, in the method, the communication device is implemented in the form of a mobile telephone.

Preferably, in the method, said at least one object comprises at least one of pictures, photographs, movies, standard SMS messages, quotes, words and emoticons. For example, contemporary mobile telephones are known to have a “T9” capability such that, on input of a starting letter of a word, the user is presented with a list of words utilizing the letter for the user to select amongst.

According to a second object of the invention, there is provided a communication device operable to predict input of electronic objects thereto, the device including:

(a) a first database of electronic objects susceptible to being inserted into multimedia messages composable on the device;

(b) a second database of electronic object attributes;

(c) associating means for establishing one or more associations between at least one object of the first database and at least one corresponding attribute of the second database;

(d) request receiving means for receiving from a user of the device a request for inclusion of one or more of the objects into a multimedia message, said request including at least one input argument;

(e) computing means for matching said at least one input argument with said at least one attribute in the second database and for identifying one or more objects corresponding to the at least one input argument and its associated at least one attribute; and

(f) displaying means for presenting to the user a display representation of said one or more objects corresponding to said at least one argument.

The invention has the advantage that it is capable of addressing at least one of the objects of the invention.

Preferably, in the device, said computing means is operable to present to the user said one or more identified objects in a prioritised manner relative to other objects in the first database.

Preferably, the device is operable to present said one or more identified objects firstly on the displaying means to the user in response to the request.

Preferably, in the device, said computing and said displaying means are operable to present said identified objects in an order wherein objects with most matching attributes to said one or more arguments are presented firstly in progressive order to those objects with least matching attributes to said one or more arguments.

Preferably, in the device, at least one of the objects of the first database is associated with a plurality of corresponding attributes in the second database.

Preferably, in the device, said one or more attributes include at least one of:

(a) relationship of the user to one or more intended recipients of the message;

(b) a degree of desired informality of said message;

(c) chronological time of at one of an instance of generating the message and an instance of despatching said message;

(d) ambient conditions of the user when composing the message, said conditions including at least one of ambient illumination intensity, ambient temperature, ambient humidity, ambient altitude;

(e) geographical spatial location of the user when at least one of composing and sending the message;

(f) location of the user in accordance with the location function;

(g) a previous history of a preferred selection of said one or more objects exercised by the user;

(h) at least one of a telephone number and a cyberspace address of said one or more intended recipients for the message; and

(i) a word already part of the message.

Preferably, the device includes position measuring means for determining its geographical spatial location. More preferably, said measuring means includes at least one of an A-GPS and an E-OTD position measuring apparatus.

Preferably, in order to render the device easier to use, the device is operable to relate the geographical spatial location to the user location in accordance with the location function. Location function includes definitions such as “home”, “work”, “office”, “factory”, “on vacation”, and so forth.

Preferably, the device is operable to display a representation of at least one of the identified objects on the displaying means together with one or more of its associated attributes.

Preferably, the device is operable to represent said identified objects in a manner susceptible to interrogation from the user by way of scrolling representation of the identified objects. For example, the scrolling presentation is beneficially presented in the form of at least one of text and icons.

Preferably, in the device, said first and second databases are substantially co-located in the memory of the device. More preferably, with regard to the device, at least part of said first and second databases is provided spatially remote with respect to the device. Such remote provision of the first and second database includes, for example, electronic objects downloaded from the Internet when composing a multimedia message.

Preferably, said device is arranged to be operable to present to the user objects grouped in accordance with one or more of their attributes.

Preferably, said device is implemented in the form of a mobile telephone.

Preferably, in the device, said at least one object comprises at least one of pictures, photographs, movies, standard SMS messages, quotes, words and emoticons. However, it is to be assumed that multimedia messages will usually include text as well as one or more of the aforementioned objects.

It will be appreciated that features of the invention are susceptible to being combined in any combination without departing from the scope of the invention.

### BRIEF DESCRIPTION OF THE DRAWINGS

Embodiments of the invention will now be described, by way of example only, with reference to the drawings, wherein:

FIG. 1 is an illustration of lists of parameters for a communication device, the lists being interrelated by mapping functions F1, F2 and F3; and

FIG. 2 is an illustration of emoticon and relation lists from FIG. 1 and operation of the mapping function F1; and

FIG. 3 is an illustration of a method of composing a multimedia message on a communication device.

### DESCRIPTION OF EMBODIMENTS

In overview, the inventor has appreciated that contemporary communication devices facilitating electronic object entry merely provide various lists of characters, for example, emoticons, which device users are capable of selecting according to one or more convenient approaches. In consequence, such devices are tedious and slow to use in practice when composing multimedia messages including one or more objects. In order to address such problems, the inventor has identified that it is desirable to arrange for such devices to be capable of intelligently predicting one or more objects that the users are likely to desire to use and presenting such a selection to the users, thereby reducing an amount of information that the users are obliged to process in order to select their preferred one or more objects. In particular, the inventor has appreciated that prediction of suitable objects is susceptible to being based on at least one of:

(a₁) relationship between a user sending a message and one or more corresponding users to whom the message is to be sent;

(b₁) user desire for informal or formal nature of communication;

(c₁) measurable parameters affecting a user sending a message to one or more corresponding users, for example, one or more of chronological time, ambient illumination intensity, altitude, humidity and/or temperature at which a message is prepared or composed;

(d₁) geographical location at which a message is being composed; and

(e₁) objects which a user is previously in a habit of using and/or has demonstrated a preference to using.

Such prediction is of benefit in that it is capable of enabling a user of a communication device, for example, a mobile telephone, to achieve faster and more convenient insertion of electronic objects when composing multimedia messages, for example EMS or MMS messages.

Thus, the inventor has envisaged a method of enabling mobile telephones to predict which electronic objects a user wants to insert into a multimedia message. Such objects preferably correspond to at least one of an emoticon, a picture, an animation and a sound. Moreover, such a multimedia message preferably corresponds to a contemporary EMS or MMS message.

As an embodiment of the invention, a user actuates a button of a mobile communication device including an associated graphical display, actuation of the button being operable to trigger display on the display a first part of a list of multimedia objects; the objects beneficially resemble insertion of a symbol in a Microsoft Word document. Alternatively, actuation of the button causes scrolling through a list of multimedia objects; such objects beneficially resemble insertion of one or more alphabetical characters in an SMS message as encountered in contemporary mobile telephones.

The present invention will now be described in greater detail.

With the advent of enhanced messaging service (EMS) and multimedia messaging service (MMS), a user of a communication device, for example, a mobile telephone, is confronted with a choice of selecting and sending one or more of still pictures, emoticons, sounds and animated pictures as objects when composing a multimedia message. However, in practice it is found difficult for the user to select amongst numerous objects to identify a suitable choice. For example, on a miniature relatively low-resolution pixel liquid crystal display screen as incorporated into many contemporary mobile telephones, often as many as fifty pictures are listed as potential objects, which takes considerable time for the user to view amongst and to select a most appropriate object for a specific desired purpose; for example, such a most appropriate object is susceptible to corresponding to an image of a birthday cake with burning candles thereon when a user desires to send a birthday greeting text message to another user on the occasion of his/her birthday. In consequence, where the user has insufficient time or patience to review all fifty pictures, there is a probability that a picture is effectively selected substantially at random from the list. Such a selection is potentially susceptible to subsequent correction which itself represents an inconvenient and tedious activity.

The inventor has appreciated that selection amongst the fifty pictures is less likely to be at random or erroneous if the user is presented with a predicted list of objects which are most likely relevant to the nature of the message that the user is about to prepare and/or compose; the predicted list is beneficially considerably shorter than a corresponding list of all possible object options. As elucidated in the foregoing, such a prediction is preferably based on at least one of:

(a₂) a relationship between a user sending a message and one or more users receiving the message, for example, such a user being a friend, a mother, a father, an ex-marital mistress, and so forth;

(b₂) a type of communication, for example, whether it is formal or informal;

(c₂) an instance of time at which a message is being composed, for example, at noon; and

(d₂) a geographical location at which the message is composed and/or sent, for example, from home, from work, from a mistress' house, and so forth.

The prediction is optionally susceptible to being also dependent upon other factors as elucidated in the foregoing.

Approaches to providing predictable selection according to the invention will now be described.

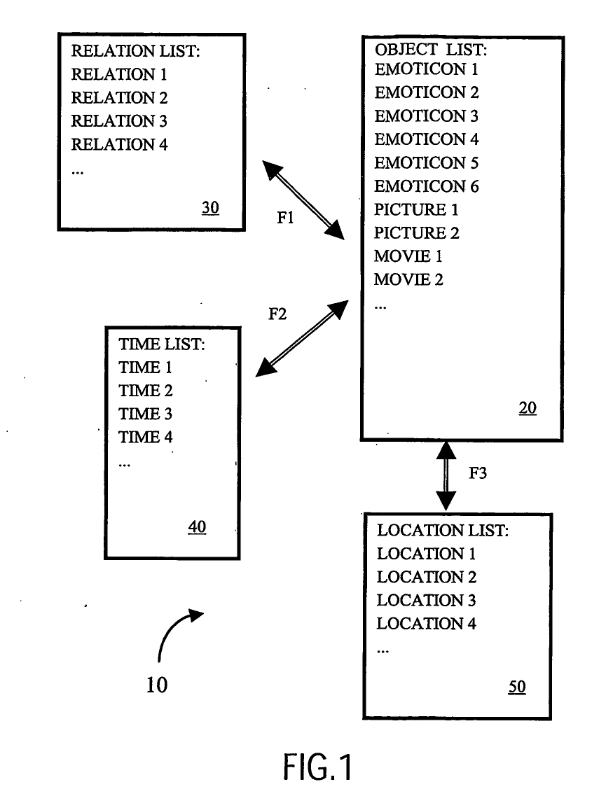

FIG. 1 shows an interrelation arrangement indicated generally by 10. The arrangement 10 includes an object list 20, a relationship list 30, a time list 40 and a location list 50. Other lists are possible, for example a temperature list and a list associating degrees of formality/informality to one or more of the objects in the object list 20, and a list defining appropriate times at which one or more of the objects are suitable for inclusion in multimedia messages. The lists 20, 30, 40, 50 are at least one of:

(a₃) pre-programmed into a communication device, for example, a mobile telephone;

(b₃) downloaded by a user to the device from an external source such as the Internet and/or lap-top computer; and

(c₃) input to the device via its data entry facility, for example, a keypad and/or CCD camera integral to the device.

The lists 20, 30, 40, 50 are stored in the memory of the device, for example, as volatile and/or non-volatile memory, for example, flash memory. Items in the lists 20, 30, 40, 50 are associated by way of functions F1, F2, and F3. The functions F1 to F3 themselves are preferably implemented in the device as data fields which are beneficially stored in the memory of the device. In a similar manner to the lists 20, 30, 40, 50, one or more of the functions F1 to F3 are at least one of:

(a₄) pre-programmed into the communication device;

(b₄) downloaded by the user to the device from an external source such as the Internet and/or a laptop computer;

(c₄) input to the device via its data entry facility, for example, its key-pad; and

(d₄) from a history of previous associations made by the user between the lists 20, 30, 40, 50, for example, as a consequence of composing earlier multimedia messages accessing one or more of the lists 20, 30, 40, 50.

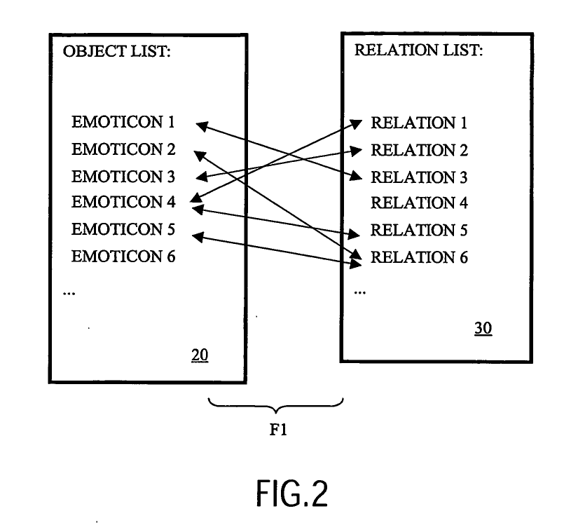

FIG. 2 shows the function F1 associating specific example elements in the lists 20, 30, namely:

(a₅) a multimedia message being composed for sending to a Relation 3 results in the user being prompted by a display symbol corresponding primarily to an Emoticon 1;

(b₅) a multimedia message being composed for sending to a Relation 6 results in the user being prompted by a display symbol corresponding primarily to Emoticons 2,5; and

(c₅) an Emoticon 4 being presented as a display symbol to prompt the user when the user composes a multimedia message addressed to either a Relation 1 and/or a Relation 5.

It will be appreciated that, although the user is prompted by a most appropriate subset of objects as determined by the functions F1 to F3, the user is preferably also capable of selecting, if desired, amongst all objects stored in the device, although it is appreciated that such a selection amongst all the objects is potentially tedious as in the prior art. The inventor has appreciated that such non-specific selection amongst all the objects is likely to be a rare occurrence on account of associated tediousness in situations where the present invention is implemented.

Thus, when composing a multimedia message on the device, the user is prompted by a preferred selection of objects, the selection being determined by a selection function having a general form as provided in Equation 1 (Eq. 1):
OS=G(R,I,t,x,y,z,p,T,Fₙ,i) Eq. 1
wherein
OS=object selection for display to the user, for example, as a graphics icon and/or list entry;
G=an object selection function determining graphical information presented to the user when composing one or more multimedia messages, the function G having one or more of the following arguments, the function G giving rise to a graphic symbol such as a graphics icon or list entry presented to the user on a display of the device, the user being operable to highlight the icon and/or list entry as desired, thereby instructing the device whether or not to insert the object selected in the multimedia message being composed:
i=a reference index for a present object being processed by the function G, namely each entry in the object list 20 has associated therewith an index value; for example, in FIG. 1 a first entry in the object list 20 corresponding to i=1 is “Emoticon 1”, a second entry in the list 20 corresponding to i=2 is “Emoticon 2”, and so on;
R=input data from the relation list 30 together with a relation selection made by the user regarding a multimedia message currently being composed;
I=input data from a user regarding associated formality/informality grading for one or more of the objects in the object list 20 together with an informality/formality selection made by the user regarding the message currently being composed, for example, formal, informal and/or business;
t=input data from the time list 40 together with a measure of time at which the message is being composed and/or scheduled to be sent;
x, y, z=spatial location of the user at which the user is composing the message; x, y, z are Cartesian co-ordinates defining map location and altitude; if required, other spatial defining parameters are susceptible to being employed, for example, polar co-ordinates; moreover, the parameters x, y, z are susceptible to being defined by one or more of A-GPS, E-OTD or the like; as a further alternative, user-friendly expressions such as “home”, “office”, “golf course”, “en route”, “abroad” are susceptible to being additionally or alternatively employed for defining category of spatial location;
p=probability index for displaying the object associated with the function G, for example, on account of this object being frequently selected in the past by the user because of personal preference and/or style;
T=an indication of temperature at which the message being composed is prepared, for example, the parameter T is susceptible to being generated from a temperature sensor included within the device so that summer-relevant objects are more preferably presented by the function G at relatively higher temperature of the order of 30° C. or higher, and
Fₙ=association function associating objects in the list 20 with parameters of the other lists 30, 40, 50 as described in the foregoing with reference to FIGS. 1 and 2.

Thus, during composition of a multimedia message on the device, the function G is invoked repetitively whenever the user wants to insert an object into the multimedia message. Preferably, the device is operable to search all objects stored therein and only forward an indication to the display of the device when a match is identified on the basis of the arguments of the function G in Equation 1.

Associated with the relation list is preferably a list of telephone numbers and/or cyberspace contact codes.

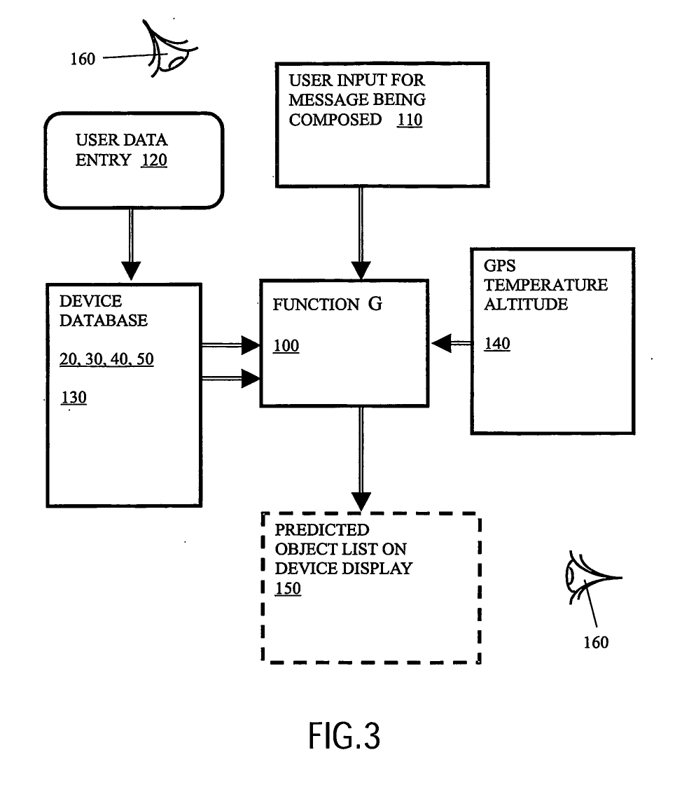

Operation of the aforesaid device when composing a multimedia message will now be described in more detail, also with reference to FIG. 3.

The user 160 interfaces with the device in an operation state by indicating the user's desire to compose a message 110, for example, by highlighting a “compose message” icon on a graphic display 150 of the device. The device then prompts the user for details such as:

(a₆) whether or not the message to be composed is formal, informal and/or business;

(b₆) one or more proposed recipients for the message;

(c₆) an instance of time at which the message is to be sent and/or at which it is composed; and

(d₆) where the user is currently located, for example, office, home, en route, abroad; failing such entry, the device is preferably operable to determine its position automatically 160, for example, by using the global positioning system (GPS), to determine its spatial co-ordinates and then referring to the location list 50 to determine a suitable argument for input to the function G 100.

It will be appreciated in (a6) and (b6) above that it is also possible that a telephone number is already associated with a type of communication, namely a priori; namely, earlier information may already exist to determine whether a message to a defined recipient is formal or informal.

Once having entered relevant data in (a₆) to (d₆) above, the user 160 then inputs text of the multimedia message 110. At one or more points within the message being composed, the user 160 indicates a desire to include an object by invoking an “object insert” function, for example, by highlighting an appropriate corresponding graphics icon on the display 150 of the device. The device then invokes the function G, namely 100, repetitively to scan through preferably all objects present within a database 130 of the device as entered earlier 120, and, if required, external objects available to the device, for example, from a telephone wireless network provider, and select those objects for which there is a match, for example:

(a₇) a given object from the list 20 has by way of the function F, a relation entry in the list 30 which matches said one or more proposed recipients for the message in (a₆) above;

(b₇) the user 160 has not yet specified one or more proposed recipients in (a₆) above but nevertheless has indicated to the device that a business message is desired to be composed; and

(c₇) the user 160 is in a habit of very frequently invoking a particular object, for example, a company logo where the user 160 is a sales representative making presentations to potential future clients, the device therefore including such a popular object for the user 160 to select, even though not directly normally associated with the one or more intended recipients specified by the user 160.

The user 160 selects one or more objects from the list presented on the display 150 of the device and continues, if required, re-invoking the function G 100 for further objects to be included at other parts of the message, before finally indicating to the device that the message should be sent to the one or more proposed recipients.

Thus, the function G 100 is capable of sorting by way of; for example, spatial location, object, relationship, type of communication such as informal/formal/business, although other modes of sorting are also preferably accommodated.

The aforementioned device according to the invention is susceptible to including the following preferable features:

(a₈) the device is capable of estimating its own position, for example, by way of A-GPS, E-OTD and by way of related position determining facilities;

(b₈) the user and/or the device are capable of mapping different geographical locations against different real-life places such as “Office”, “Home”, “Favourite Club”, “Favourite Drinking Bar”. Such an association of spatial location to location function is preferably executable by the user 160 manually or via access to an external network to the device, for example, the Internet;

(c₈) the user 160 in the device database 130 is able to map different telephone numbers and/or e-mail addresses to different real-life “number-relationships—type of communication” classes by way of functions similar to the aforementioned functions F1 to F3; for example, “number-friend-formal”, “number-friend-informal”, “number-customer-formal”, “number-business_partner-formal-business”;

(d₈) on the display 150, operating software of the device driving the display 150 so that one or more objects, for example, one or more emoticons, from the list 20 displayed, are tagged at least in abbreviated form symbol format on the display 150 for the user 160 to select so as to identify to the user 160 whether or not it is a formal picture, an informal picture, a business picture or an emoticon;

(e₉) in a similar manner to (d₈), one or more of the objects in the list 20 are susceptible to being tagged only with a relationship from the list 30. For example, an emoticon depicting a dancing monkey can be tagged as being a “friend icon”. Thus, an object in the form of a picture is susceptible to being tagged as “picture-friend” or “picture-formal” for single argument relationships or even “picture-friend-formal” for multiple argument relationships;

(f₈) the device is preferably arranged to support an abbreviation syntax on the display 150, for example, “9856712536-f-i” where an argument “f” denotes a friend's telephone number and an argument “i” denotes that communication to the number 9856712536 is of an informal nature; in consequence, when the user 160 composes a multimedia message for this friend, the user 160 is presented on the display primarily with objects from the list 20 which are designated at entry 120 to be of an informal nature. In order to further elucidate the present invention, a specific simple example embodiment of the invention will be described.

The user 160 is at his/her house and wants to send a multimedia message to his/her friend using the communication device; for example, the device is implemented in the form of a mobile telephone. A spatial location of the user 160 and his/her associated device is estimated either by a user schedule 120 input earlier to the device, or by using positioning techniques such as, for example, A-GPS.

In a first step, the user 160 selects a telephone number corresponding to a friend. Such a selection causes the device via its function G 100 to present on the display 150 those objects in the list 20 stored in the database 130 which are tagged by one or more functions F to be informal. The objects presented are preferably displayed in concise form to facilitate easy scrolling on the display 150. Moreover, on the display 150, objects being tagged by the aforementioned functions F as being “friend” and “informal” are displayed first, followed by objects tagged as being “friend” but without formality tagging, followed by objects tagged as being “informal” but without relation tagging set.

In a second step, the user 160 selects from the scrolled list, thereby inserting the corresponding selected object into the multimedia message.

In a third step, when the message has been completed, the user 160 proceeds to send the message to the friend. Moreover, the friend subsequently opens the e-mail and reads the multimedia message including its various associate objects, for example, one or more of the aforementioned emoticons, pictures, photographs, movie clips, and so forth.

It will be appreciated that embodiments of the invention described in the foregoing are susceptible to being modified without departing from the scope of the invention.

In defining relationships in the foregoing, a logical relation sequence preferably has a form where defined objects (OBJ) may be used with defined relations (REL), may be used in defined types of communication (TYP), or may be used in defined telephone numbers (NUM), namely symbolically in a manner:

OBJ <=> REL <=> TYP <=> NUM

In the foregoing, the use of verbs such as “comprise”, “incorporate”, include”, “contain” and their conjugations is to be construed to be non-exclusive, namely allowing for the presence of other parts or items not explicitly disclosed. ‘Computer program’ is to be understood to mean any software product stored on a computer-readable medium, such as a floppy disk, downloadable via a network, such as the Internet, or marketable in any other manner.

1. A method of predicting input of electronic objects in a communication device, the method including the steps of:
(a) establishing a first database of electronic objects susceptible to being inserted into multimedia messages composable on the device;
(b) establishing a second database of electronic object attributes;
(c) establishing one or more associations between at least one object of the first database and at least one corresponding attribute of the second database;
(d) receiving from a user of the device a request for inclusion of one or more of the objects into a multimedia message, said request including at least one input argument;
(e) matching said at least one input argument with said at least one attribute in the second database and thereby identifying one or more objects corresponding to the at least one input argument and its associated at least one attribute; and
(f) presenting to the user a display representation of said one or more objects corresponding to said at least one argument.

2. A method as claimed in claim 1, wherein said one or more identified objects from step (e) are presented in a prioritised manner relative to other objects in the first database.

3. A method as claimed in claim 2, wherein said one or more identified objects from step (e) are presented firstly to the user.

4. A method as claimed in claim 1, wherein said one or more identified objects from step (e) are presented in an order wherein objects with most matching attributes to said one or more arguments are presented firstly in progressive order to those objects with least matching attributes to said one or more arguments.

5. A method as claimed in claim 1, wherein said one or more attributes include at least one of:
(a) relationship of the user to one or more intended recipients of the message;
(b) a degree of desired informality of said message;
(c) chronological time of at least one of an instance of generating the message and an instance of despatching said message;
(d) ambient conditions of the user when composing the message, said conditions including at least one of ambient illumination intensity, ambient temperature, ambient humidity, ambient altitude;
(e) geographical spatial location of the user when at least one of composing and sending the message;
(f) location of the user in accordance with the location function;
(g) a previous history of a preferred selection of said one or more objects exercised by the user;
(h) at least one of a telephone number and a cyberspace address of said one or more intended recipients for the message; and
(i) a word already part of the message.

6. A method as claimed in claim 1, wherein the device includes position measuring means for determining its geographical spatial location.

7. A method as claimed in claim 1, wherein the device includes graphical displaying means for representing said identified objects in a manner susceptible to interrogation from the user by way of scrolling representation of the identified objects.

8. A method as claimed in claim 1, wherein the device is arranged to be operable to present to the user objects grouped in accordance with one or more of their attributes.

9. A computer program product enabling a programmable device to perform a method as claimed in claim 1.

10. A communication device operable to predict input of electronic objects thereto, the device including:
(a) a first database of electronic objects susceptible to being inserted into multimedia messages composable on the device;
(b) a second database of electronic object attributes;
(c) associating means for establishing one or more associations between at least one object of the first database and at least one corresponding attribute of the second database;
(d) request receiving means for receiving from a user of the device a request for inclusion of one or more of the objects into a multimedia message, said request including at least one input argument;
(e) computing means for matching said at least one input argument with said at least one attribute in the second database and for identifying one or more objects corresponding to the at least one input argument and its associated at least one attribute; and
(f) displaying means for presenting to the user a display representation of said one or more objects corresponding to said at least one argument.
